(19) United States
(12) Patent Application Publication
(10) Pub. No.: US 2013/0178166 A1
(43) Pub. Date: Jul. 11, 2013

(54) METHOD AND APPARATUS FOR PROVIDING OUTSIDE NETWORK SERVICE BASED ON ADVERTISMENT VIEWING

(71) Applicants: Jun-Hyung Kim, Gyeonggi-do (KR); Je-Young Maeng, Gyeonggi-do (KR)

(72) Inventors: Jun-Hyung Kim, Gyeonggi-do (KR); Je-Young Maeng, Gyeonggi-do (KR)

(21) Appl. No.: 13/823,512

(22) PCT Filed: Oct. 5, 2011
(86) PCT No.: PCT/KR2011/007380

§ 371 Date: Mar. 14, 2013

(30) Foreign Application Priority Data
Oct. 5, 2010 (KR) 10-2010-0097062 5

(51) Int. Cl. H04M 3/487

(52) U.S. Cl. CPC H04M 3/4878
USPC 455/41.2

(57) ABSTRACT

Disclosed is a telephony service in a public place, and a method and an apparatus for an advertisement viewing based free telephony service. The method includes a process in which a telephony client requests a free call service in order to enable a specific telephony client to use the telephony service free of charge in a public place such as a subway, a process of providing an advertisement to a telephony client having requested the service, and a process of setting a telephony server in order to enable a telephony client having received an advertisement to use the service.

### TECHNICAL FIELD

The present invention relates to a telephony service, and more particularly to a method and an apparatus for a free telephony service based on advertisement viewing in a public place.

### BACKGROUND ART

In general, a home network includes a private network based on an Internet Protocol (hereinafter, referred to as an “IP”). Such a home network connects various devices such as a Personal Computer (PC), an intelligent product, and a wireless device to one network through middleware, which is a common virtual computing environment, to control them. Here, middleware enables communication between various devices by connecting the devices in a peer-to-peer manner. Up to now, HAVI (Home AV Interoperability), UPnP (Universal Plug and Play), Jini (Java Intelligent Network Infrastructure), HWW (Home Wide Web), etc. are proposed as middleware.

Among the listed middleware, UPnP middleware is a technology which is most frequently used currently. In a computing environment constructed by UPnP middleware, each device receives an allocation of an address from a server according to a Dynamic Host Configuration Protocol (DHCP), or an address selected through an auto IP (Internet Protocol) designating function. Through the allocation of the address, devices communicate with each other, and search and inquiry are performed on a network.

A UPnP network defines a UPnP device, a UPnP service, and a protocol between the UPnP device and the UPnP service. Such a UPnP network includes a Controlled Device (CD), which is a home network device controlled while being connected to an IP based home network, and a Control Point (CP), which is a device controlling the controlled device. The control point is a device, which performs a control for the controlled device.

First, the control point is a device, which performs a control for the controlled device. The control point requests an event from the controlled device, and receives the event from the controlled device.

The controlled device is a device, which performs a function determined according to a request of the control point. The controlled device transmits the requested event to the control point having requested the event when a state of the controlled device is changed.

UPnP network devices as configured above perform an advertisement process, a discovery process, a description process, a control process, and an event process. Referring to the processes more specifically, the advertisement process is a process in which a new controlled device is connected to a home network to notify its existence to other devices on the home network. The discovery process is a process in which a new control point is connected to a home network to search for controlled devices operating on the home network. The description process is a process in which the control point parses a service description XML (eXtensible Markup Language) file or a device description XML file to grasp a function of a newly added device in more detail through an IP address of the searched controlled device in order to control the controlled device. The control process is a process in which, when the control point desires to provide a specific service through the controlled device, the control point transmits a control message (action request) including a request for a predetermined service to the corresponding controlled device by using a SOAP (Simple Object Access Protocol) according to a UPnP device architecture and receives a response message (result, variable value) in response to the control message. The event process is a process in which the control point identifies a change state for information of the controlled device having provided the predetermined service by the control command transmitted from the control point.

A UPnP telephony technology is being manufactured in which call data received based on the aforementioned UPnP technology is transmitted to a device within the home so that a user can communicate by using the device within the home. According to the UPnP specification, a UPnP telephony architecture includes a telephony terminal receiving a call from an outside, an electronic device within the home receiving call data from the telephony terminal, and a control point controlling the two devices, which are the telephony terminal and the electronic device within the home. The control point can control functions of the telephony terminal and the electronic device by using a network, and is responsible for connecting the two devices and establishing a media session. The telephony terminal receiving a call is a telephony server. The electronic device receiving call data from the telephony server, that is, a telephony device is referred to as a telephony client. A telephony control point makes a control such that a call received at the telephony server is transmitted to the telephony client.

### DISCLOSURE OF INVENTION

### Technical Problem

The UPnP telephony service has been made to enable a user to use a telephone service within the home. Accordingly, a CE (Consumer Electronics) device within the home such as a home panel has been considered as a target device for a main telephony service. Further, a mobile device providing mobility is also considered as a device suitable for using the telephony service. The mobile device may be used in a small scale network configured within the home and also be used in a small scale network configured outside the home identically to that within the home. However, additional costs may be required to use the telephony service in public places such as a bus and a subway.

### Solution to Problem

Accordingly, the present invention provides a method and an apparatus for enabling a user to use the telephony service by using a public infrastructure in a public place.

Further, the present invention provides a method and an apparatus in which a user receives an advertisement including an image, voice, and a text for the use of a free telephony service by using a public infrastructure.

Moreover, the present invention provides a method and an apparatus for a service access restriction for allowing only a user device having received an advertisement to use the telephony service.

Furthermore, the present invention provides a method and an apparatus, which may be applied to various services such as an advertisement viewing based internet using service as well as the advertisement viewing based telephony service in a public place.

In addition, the present invention provides a method and an apparatus, which may be applied when a free telephony service within the home is used as well as when the free telephony service in a public place is used.

In accordance with an aspect of the present invention, there is provided a method of performing Short Distance Communicaiton with at least one electronic device and providing a service using an outside network to the electronic device, the method including allocating an IP address to an electronic device and blocking an outside network access of the electronic device; receiving a request message for an outside network service from the electronic device; identifying whether the electronic device has an access right for an outside network; when the electronic device has no access right, transmitting an advertisement to the electronic device; when an advertisement viewing report message is received from the electronic device, giving the access right to the electronic device and allowing an access to the outside network; and providing the outside network service to the electronic device.

In accordance with an aspect of the present invention, there is provided a method for receiving a service using an outside network from a gateway, which performs Short Distance Communicaiton with one or more electronic devices and establishes a network, by a particular electronic device among the one or more electronic devices, the method comprising: receiving an allocation of an IP address from the gateway; transmitting a request message for an outside network service to the gateway; receiving a notification that the electronic device has no access right for a network from the gateway; receiving an advertisement from the gateway; transmitting an advertisement viewing report message corresponding to the advertisement to the gateway; and receiving the outside network service from the gateway.

### Advantageous Effects of Invention

Through the present invention, the user can receives the telephony service free of charge in a public place by using a mobile device belonging to the user. Further, the user can use the telephony service free of charge even within the home through advertisement viewing. Furthermore, an advertiser can directly transfers an advertisement to a private electronic device so that an efficiency of the advertisement may be increased.

### BRIEF DESCRIPTION OF DRAWINGS

FIG. 1 illustrates a basic construction of a UPnP telephony system according to an embodiment of the present invention;

FIG. 2 illustrates a process of providing an advertisement viewing based telephony service according to an embodiment of the present invention;

FIGS. 3 and 4 illustrate processes in which a mobile gateway provides a service access control for a telephony service request of a mobile device according to an embodiment of the present invention;

FIG. 5 illustrates a construction of a mobile gateway for using a telephony service according to an embodiment of the present invention;

FIG. 6 illustrates a construction of a mobile device for providing an advertisement and using a telephony service in a public place according to an embodiment of the present invention;

FIGS. 7 and 8 illustrate processes of providing a public telephony service according to embodiments of the present invention;

FIG. 9 illustrates a construction of a mobile gateway according to another embodiment of the present invention; and

FIG. 10 illustrates a construction of a mobile device according to another embodiment of the present invention.

### MODE FOR THE INVENTION

Hereinafter, the first exemplary embodiments of the present invention will be described with reference to the accompanying drawings. Specific matters found in the following description, such as a detailed explanation of components are provided only to help general understanding of the present invention, and it is apparent to those skilled in the art that various changes and modifications may be made therein without departing from the spirit and scope of the invention as defined by the appended claims. Further, in the following description of the present invention, a detailed description of known functions and configurations incorporated herein will be omitted when it may make the subject matter of the present invention rather unclear.

When an electronic device configuring a small scale network implemented through Short Distance Communicaiton (SDC) desires to receive a service provided through a public network by accessing the public network connected through a gateway, the present invention provides a predetermined advertisement to the electronic device and enables the electronic device to access the public network after the electronic device completely consumes the provided advertisement.

According to the present invention, when the electronic device enters a small scale network, the gateway allocates an IP address so that communication using a home network is possible but a port, which can access an outside network such as an internet network, a mobile communication network, or a public network, is blocked off. Further, when there is a request for an access to the outside network by the electronic device or a request for a service provided through the outside network, a predetermined advertisement is provided to the electronic device. The electronic device consumes the provided advertisement by reproducing the advertisement, and notifies the gateway of the advertisement consumption. When the gateway identifies the advertisement consumption of the electronic device, the gateway releases the blocked port in order to enable a corresponding electronic device to access the outside network, and provides the requested service.

When the gateway determines that the electronic device has no outside network access right, processes of providing an advertisement to the electronic device may be divided into two embodiments. First, when the gateway determines that the electronic device has no outside network access right, the gateway directly and automatically provides information on an advertisement, which is to be received at the electronic device, to the electronic device. Second, when the gateway determines that the electronic device has no outside network access right, the gateway induces an advertisement reception of the electronic device and makes the electronic device access information on an advertisement, which is to be received at the electronic device, from the gateway.

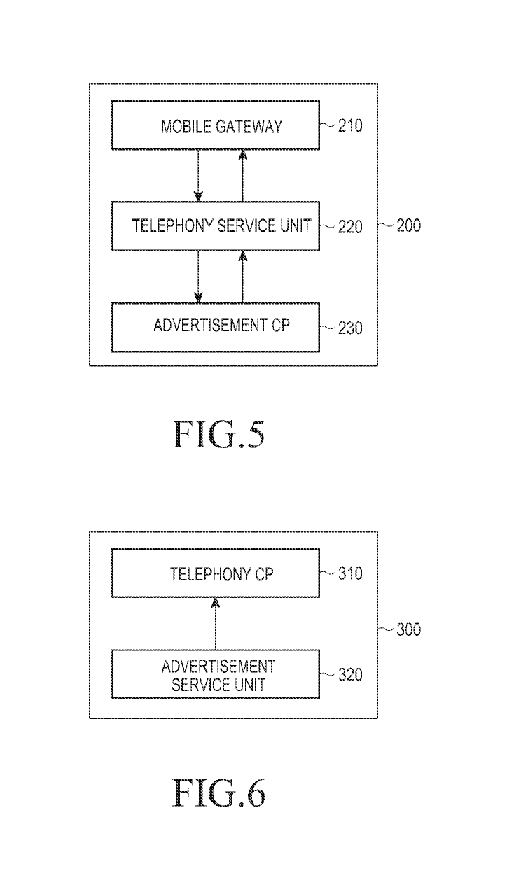

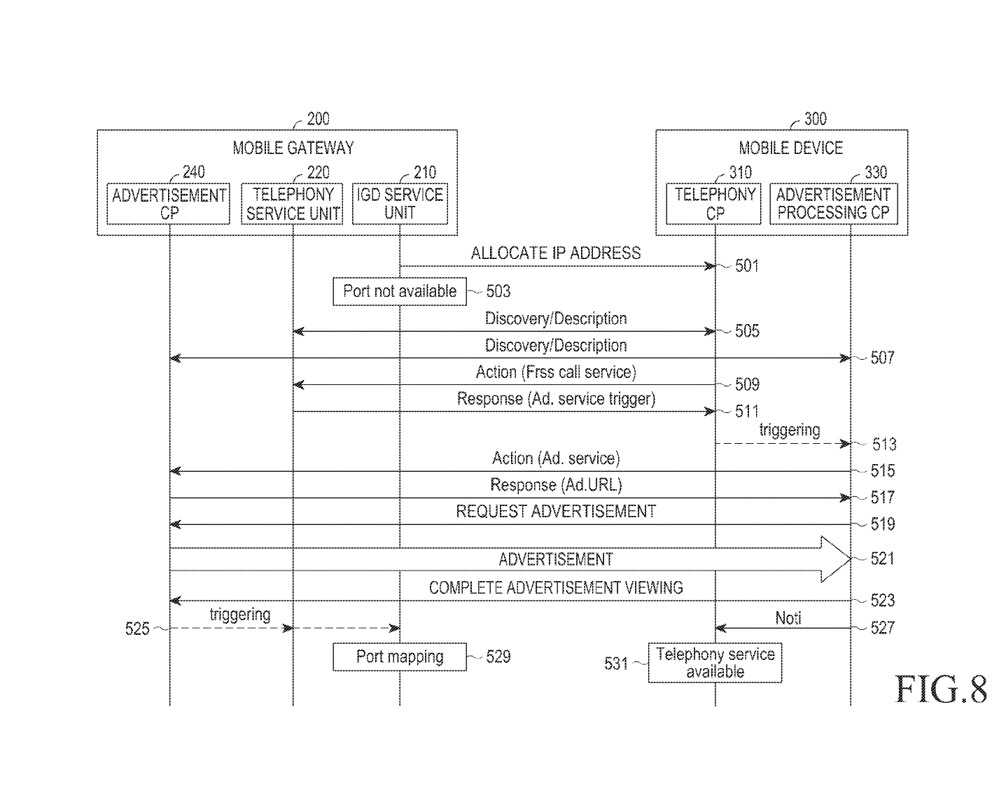

Hereinafter, a case where the telephony service is provided in a small scale network to which the UPnP is applied will be described as an example of the present invention. Further, a case where the small scale network is implemented in a public place such as public transportation will be described as an example. FIGS. 5, 6, and 7 illustrate the first embodiment, and FIG. 8 illustrates the second embodiment.

In embodiments of the present invention, public transportation is considered as a public place, but all small scale networks having a wireless LAN access point including a network within the home may be the public place. Further, the UPnP is described as an embodiment of communication and a service technology, which may be used in the small scale network, but the UPnP may be applied to another network technology.

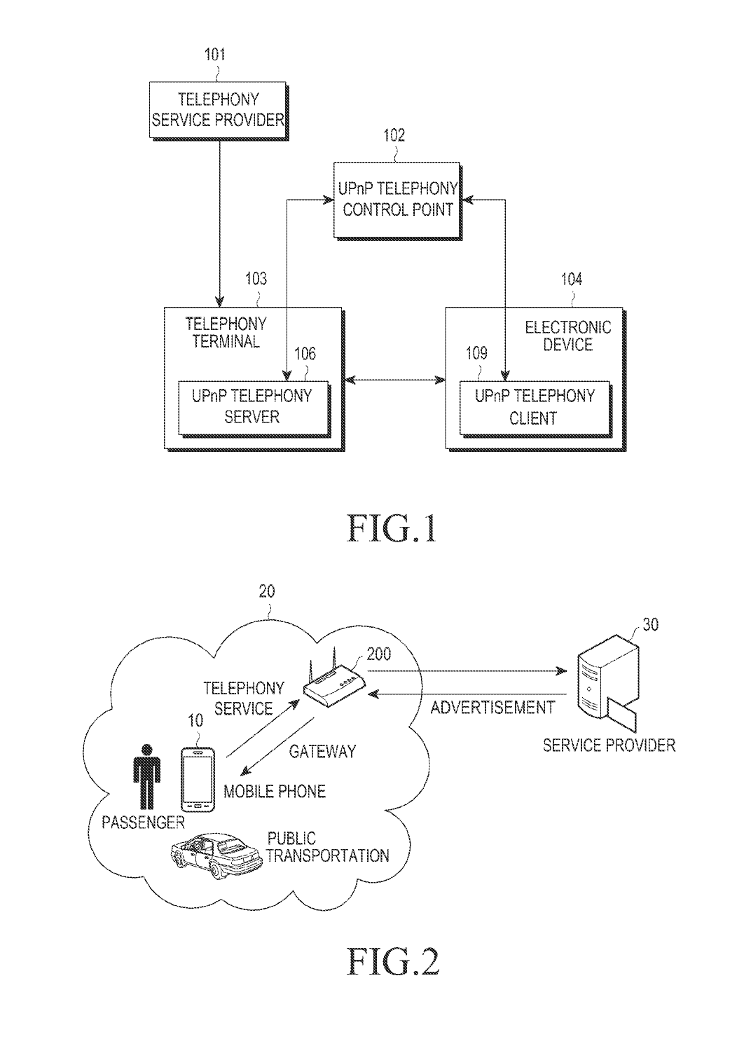

First, in order to assist understanding of the present invention, a basic construction of a UPnP telephony system is described with reference to FIG. 1. FIG. 1 illustrates the basic construction of the UPnP telephony system. The UPnP telephony system includes a telephony service provider 101, a UPnP (Universal Plug and Play) telephony control point 102 (hereinafter, referred to as a “control point”), a telephony terminal 103, and an electronic device 104. Here, the telephony terminal 103 and the electronic device 104 are located within a space where communication is possible by using the control point 102 and a UPnP protocol.

The telephony service provider 101 provides a telephony service, and provides an interface for transmitting and receiving a call, to the telephony terminal 103.

The UPnP telephony control point 102 is a logical software module, which controls a UPnP telephony sever 106 and a UPnP telephony client 109 by using a UPnP action. The UPnP telephony control point 102 may be included in a device such as a PC (Personal Computer), a smart phone, or a PDA (Personal Digital Assistant) separately from the telephony terminal 103 and the electronic device 104, but may be also included in a physical device such as the telephony terminal 103 or the electronic device 104. If the UPnP telephony control point 102 is included in the physical device such as the telephony terminal 103 or the electronic device 104, the UPnP telephony control point 102 can directly control the UPnP telephony server 106 or the UPnP telephony client 109 without the use of the UPnP action.

The UPnP telephony control point 102 determines a medium, a protocol, and a transmission format, which will be used for a call transmission/reception, by using capability information of a call data transmission agent included in the UPnP telephony server 106 or the UPnP telephony client 109 and transmitted from the UPnP telephony server 106. Further, the UPnP telephony control point 102 creates a profile defining the determined medium, protocol, and transmission format to transmit the created profile to the UPnP telephony server 106 or the UPnP telephony client 109. As a result, the UPnP telephony control point 102 sets an environment of the call data transmission agent included in the telephony terminal 103 or the electronic device 104.

The telephony terminal 103 is a CE (Computer Engineering) device such as a telephone, a PC including a VoIP (Voice over IP) configured by software, or a physical device such as a mobile communication terminal, which is in conjunction with a communication network. The telephony terminal 103 includes the UPnP telephony server 106 configured by software. Further the telephony terminal 103 controls a call transmission/reception by using the telephony service provider 101 providing a telephony service and an interface provided by the corresponding telephony service provider 101.

The electronic device 104 is a mobile communication terminal, a CE device, which can input and output a user voice or image, such as a video telephone, and a physical device such as a PC or a TV, and includes the UPnP telephony client 109 configured by software. As described above, in the present invention, the user can conveniently transmit and receive a call at home by using the home network system.

FIG. 2 illustrates an advertisement viewing based telephony service scenario according to an embodiment of the present invention. A mobile gateway 200 is installed in a bus, which is public transportation shown in FIG. 2. The mobile gateway 200 provides the same function as a gateway for allowing an internet to be used within the home, but is wirelessly connected for mobility in a WAN (Wide Area Network) section and configures a small scale network 20 including one or more electronic devices positioned within the bus.

When a passenger gets on the bus, the passenger recognizes that the passenger himself/herself can use a free telephony service through a mobile phone 10 belonging to the passenger in the bus on which the passenger gets. When the passenger requests a telephony service, the mobile gateway 200 within the bus transfers an advertisement including an image, voice, a message to the passenger having requested the service and then executes the telephony service requested by the passenger. At this time, the advertisement transferred to the passenger is stored in the mobile gateway 200 or may be received from a service provider 30 in real time. That is, the user uses the telephony service at no cost for receiving a specific advertisement.

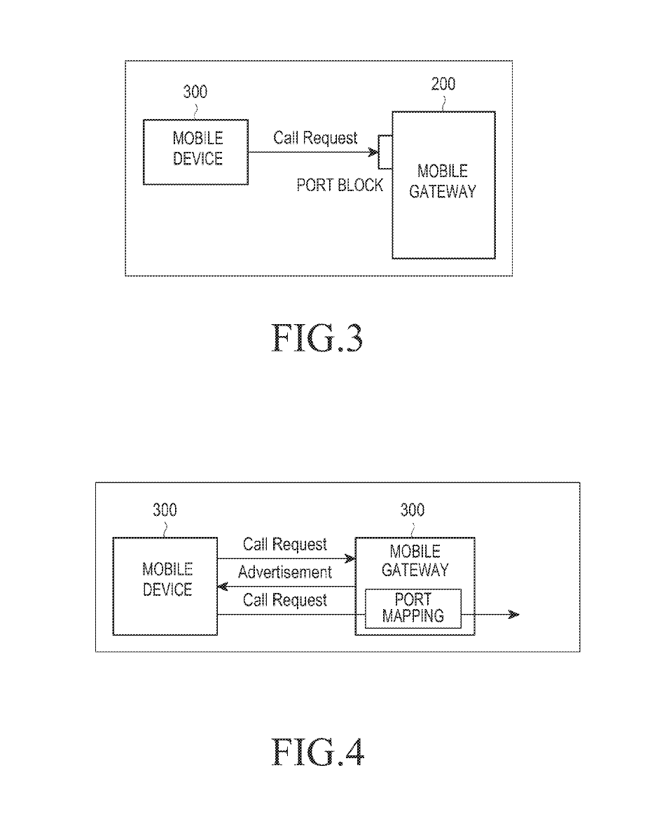

FIGS. 3 and 4 illustrate methods in which the mobile gateway provides a service access control for a telephony service request of a mobile device having a telephony client. The mobile device refers to an electronic device securing mobility. In FIG. 3, when the mobile device 300 is positioned within a bus, the mobile device 300 receives an allocation of an IP address from a DHCP server of the mobile gateway 200. At this time, the mobile gateway 200 blocks a port for accessing an outside network by using the IP address allocated to the mobile device 300. Accordingly, although the telephony service is requested through the discovery and description processes according to the UPnP by using the IP address allocated to the mobile device 300, the use for the service is not possible since the port for transferring the IP address of the mobile device 300 having requested the service has been blocked by the mobile gateway 200.

However, in FIG. 4, when the mobile device 300, which desires to use a free telephony service provided according to the present invention, makes a request for a telephony service, the mobile gateway 200 first allows the mobile device 300 to view an advertisement in response to the request for the service. When the advertisement is normally transferred to the mobile device, the mobile gateway 200 allocates a port in order to transfer the IP address of the corresponding mobile device to an outside. After the mobile device 300 views the advertisement, when the mobile device 300 makes a request for the free telephony service again, the mobile gateway 200 transfers the corresponding request to another device on an WAN.

FIG. 5 illustrates a construction of the mobile gateway 300 for using the telephony service according to an embodiment of the present invention. The mobile gateway 300 includes an IGD service unit 210 for providing a DHCP setting function and a port mapping function, a telephony service unit 220 for providing a telephony service in a public place, and an advertisement CP 230 for providing an advertisement.

The IGD service unit 210 allocates an IP address to an electronic device included in a small scale network configured by the mobile gateway 300, for example, a home network, and manages a port for an access to an outside network using the IP address allocated according to a control of the telephony service unit 200.

That is, when a request for an access to the mobile gateway 300 by a new electronic device is detected, the IGD service unit 210 allocates a specific IP address to the corresponding electronic device, allows the electronic device to access the gateway 300, and enables communication of the electronic device using the specific IP address within the small scale network configured by the mobile gateway 300.

However, a port, through which the specific IP address may be transferred to an outside network, is blocked. Further, IGD service unit 210 transfers the specific IP address and information on the corresponding electronic device to the telephony service unit 220. Next, when a command of allocating a port for the specific IP address is delivered from the telephony service unit 220, the IGD service unit 210 maps a port for enabling an access to an outside network in such a manner that the port corresponds to the specific IP address, and allows the electronic device to use the service of the outside network.

The advertisement CP 230 provides an advertisement to each electronic device included in the network configured by the mobile gateway 300 according to a control of the telephony service unit 220.

The telephony service unit 220 manages an access to an outside network for an IP address of each electronic device included in the network configured by the mobile gateway 300. Accordingly, the telephony service unit 220 constructs a list of the electronic device included in the network configured by the mobile gateway 300 and the device including the corresponding IP address. The telephony service unit 220 records access right information indicating whether an access to an outside network is allowed depending on whether each electronic device has viewed an advertisement, in the device list.

For example, when the telephony service unit 220 receives an IP address newly allocated in the IGD service unit 210 and information on the corresponding mobile device, the telephony service unit 220 adds them to the device list. Further, the telephony service unit 200 records that the access right information for the outside network of the corresponding mobile device is not allowed. Later, when the telephony service unit 220 receives a request for providing a service for enabling the use of the outside network from the mobile device, the telephony service unit 220 identifies access right information of the mobile device. As a result of the identification, when the access right information of the mobile device is not allowed, the telephony service unit 220 notifies the mobile device that the access right information of the mobile device is not allowed, and requests the advertisement CP unit 230 to provide an advertisement to the mobile device.

Subsequently, when the telephony service unit 220 is notified that the mobile device has completed receiving the advertisement, the telephony service unit 220 changes the access right information of the mobile device to a state where the access is allowed. Further, the telephony service unit 220 notifies the IGD service unit 210 that the access right information of the mobile device is allowed, and allows a port for enabling an access to an outside network to be mapped to correspond to the IP address of the mobile device.

For example, when the telephony service unit 220 receives a request for the telephony service from the telephony CP included in the mobile device, the telephony service unit 220 identifies access right information for an outside network of the corresponding mobile device. The reason why the telephony service unit 220 identifies the access right information for the outside network is that the telephony service is a service using the outside network. As a result of the identification, when the access right information is not allowed, the telephony service unit 220 requests the advertisement CP 230 to provide an advertisement to the corresponding mobile device.

The advertisement CP 230 provides URL information of the advertisement in order to allow the mobile device having requested the telephony service to view the advertisement. When the advertisement CP 230 successfully transfers the advertisement, the advertisement CP 120 notifies the telephony service unit 220 that the advertisement is successfully transferred. The telephony service unit 220 requests a port mapping for the telephony service of the mobile device having requested the service from the IGD service unit 210. When the port mapping is successfully performed, the IGD service unit 210 transmits a result of the port mapping to the telephony service unit 220. Through the above processes, the mobile device having requested the telephony service can use the telephony service.

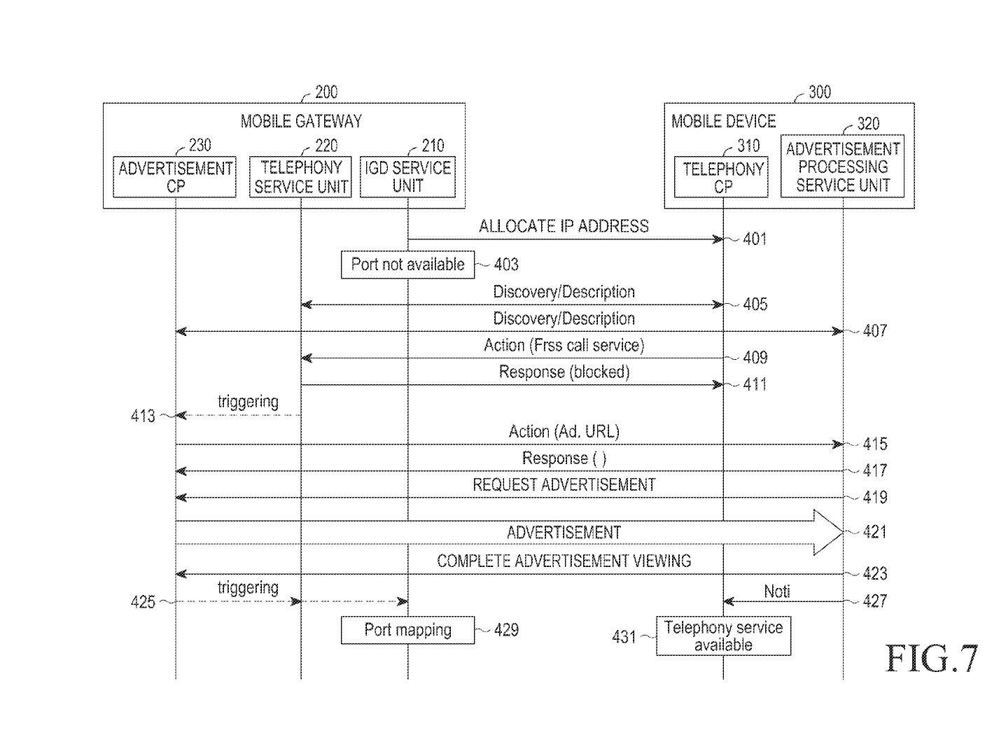

In the embodiment of FIG. 5, it is illustrated that the mobile gateway 200 includes the advertisement CP 230 according to a first embodiment in which an advertisement is provided to the electronic device, but the mobile gateway 200 may include an advertisement service unit according to a second embodiment of the present invention. Here, the advertisement service unit corresponds to the controlled device from the viewpoint of the UPnP. Actually, a function performed in the advertisement service unit is similar to that of the advertisement CP 230. That is, the advertisement service unit also provides URL information of an advertisement and the advertisement to the electronic device, and notifies the telephony service unit 220 of a successful reception of the electronic device. However, the advertisement CP 230 and the advertisement service unit have a difference in their detailed operations according to roles of the control device and the controlled device depending on a UPnP manner, and are described with reference to FIGS. 7 and 8 below.

FIG. 6 illustrates a construction of the mobile device for providing the advertisement and using the telephony service in a public place according to an embodiment of the present invention. The mobile device may include, for example, a mobile phone, a smart phone, a PMP, a PSP, a tablet PC, and a notebook.

Referring to FIG. 6, the mobile device 300 includes a telephony CP 310 and an advertisement processing service unit 320.

When the telephony CP 310 identifies the existence of a small scale network, for example, a home network by the mobile gateway 200, the telephony CP 310 requests an IP address from the mobile gateway 200. Further, the telephony CP 310 receives an allocation of the IP address from the mobile gateway 200. Then, the telephony CP 310 requests a service for enabling the use of an outside network, for example, the telephony service from the mobile gateway 200 according to a request of the user. When the mobile device 300 is allowed to access the outside network, the requested service may be provided. However, when the mobile device 300 is not allowed to access the outside network, the telephony CP 310 receives an notification that the requested service may not be provided.

The advertisement processing service unit 320 receives URL information for viewing an advertisement from the advertisement CP 230 of the mobile gateway 200. The advertisement processing service unit 320 receives the advertisement by using the received URL. When the reception of the advertisement is successfully completed, the advertisement processing service unit 320 transfers advertisement viewing completion information to the telephony CP 310. Accordingly, the telephony CP 310 identifies that the outside network service requested in advance, for example, the telephony service is possible, and performs an operation for providing the telephony service.

In the embodiment of FIG. 6, it is illustrated that the mobile device 300 includes the advertisement processing service unit 320 according to a first embodiment in which an advertisement is provided to the electronic device, but the mobile device 300 may include an advertisement processing CP according to a second embodiment of the present invention. Here, the advertisement processing CP corresponds to the control device from the viewpoint of the UPnP. Actually, a function performed in the advertisement processing CP is similar to that of the advertisement processing service unit. That is, the advertisement processing CP also provides URL information of an advertisement and the advertisement to the electronic device, and notifies the telephony CP 310 of a successful reception by the electronic device. However, the advertisement processing CP and the advertisement processing service unit have a difference in their detailed operations according to roles of the control device and the controlled device depending on a UPnP manner, and are described with reference to FIGS. 7 and 8 below.

FIGS. 7 and 8 illustrate a case where the telephony service using a public network, for example, an IP telephone service using an internet network is provided as a example.

FIG. 7 illustrates a process of providing the public telephony service proposed in the first embodiment of the present invention. Particularly, an operation process in a case where the mobile gateway 200 includes the advertisement CP 230 and the mobile device 300 includes the advertisement processing service unit 320 is described.

Referring to FIG. 7, when a passenger having the mobile device 300 gets on a bus, the mobile device 300 receives an allocation of an IP address from the IGD service unit 210 of the mobile gateway 200 in step 401.

At this time, the IGD service unit 210 within the mobile gateway 200 blocks an outside network port in order to enable the user mobile device 300 having received the allocation of the IP address in step 403 not to use an outside network service.

The telephony CP 310 of the mobile device 300 and the advertisement CP 230 of the mobile gateway 200 identify the telephony service unit 220 and the advertisement processing service unit 320 through the discovery process and the description process in step 405 and step 407, respectively.

Accordingly, the mobile device 300 can notify the user that the mobile device has accessed the mobile gateway 200, and provide a kind of services, which can be provided in a network by the mobile gateway 200. The kind of services will be provided by the telephony service unit 220 of the mobile gateway 200. The service, which can be provided, may includes a service, which should use an outside network, for example, a free telephony service, and an internet service. The user can select the free telephony service to use a free telephone service, and accordingly, the telephony CP 310 transmits a service request message for calling the free telephony service provided by the telephony service unit 220 within the mobile gateway 200 in step 409.

When the telephony service unit 220 of the mobile gateway 200 receives the request message, the telephony service unit 220 identifies outside network access right information of the mobile device 300. As a result of the identification, when the information is stored such that the access is not allowed, the telephony service unit 220 transmits a response message of informing that the service is restricted because the mobile device 300 has not viewed the current service advertisement to the telephony CP 310 of the mobile device 300 in response to the call of the free telephony service in step 411. Accordingly, the mobile device 300 can notify the user that the access is not allowed through a message display. At this time, the mobile device 300 can notify the user that the service is available when the user receives the advertisement. Further, the user can determine whether the user receives the advertisement.

The telephony service unit 310 calls the advertisement CP 230 in order to provide the advertisement to the mobile device 300 in step 413.

In order to provide an advertisement service to the mobile device according to an advertisement transmission command of the telephony service unit 310, the advertisement CP 230 transmits URL information, which is location information indicating a location of advertisement contents, to the advertisement processing service unit 320 of the mobile device 300 for advertisement viewing. The advertisement processing service unit 320 transmits a response message indicating a successful reception of an advertisement URL to the advertisement CP 230 of the mobile gateway 200 in step 417.

The advertisement processing service unit 320 of the mobile device 300 transmits an advertisement transmission request message to the received advertisement URL in step 419. At this time, the advertisement processing service unit 320 can send the advertisement transmission request message without an additional user request or can send the advertisement transmission request message only when there is a user request.

The advertisement CP 230 of the gateway 200 having received the advertisement transmission request message transmits corresponding advertisement data to the advertisement processing service unit 320 of the mobile device 300. At this time, the transmitted advertisement data may be stored in the mobile gateway 300 in advance, or received from an outside advertisement provider.

When the advertisement processing service unit 320 of the mobile device 300 completes receiving the advertisement data, the advertisement processing service unit 320 can automatically output the advertisement data, or output the advertisement data according to a user selection. For example, when the advertisement data is a dynamic image, the dynamic image may be automatically reproduced, or may be reproduced after a reproduction command by the user is received.

The advertisement processing service unit 320 transmits an advertisement viewing report message including information indicating the completion of the advertisement reception to the advertisement CP 230 at the moment when the reception of the advertisement data is completed, or transmits the advertisement viewing report message including information indicating the completion of the advertisement viewing to the advertisement CP 230 at the moment when the output of the advertisement data is completed.

When the advertisement viewing report message is received, the advertisement CP 230 transmits advertisement reception completion information to the telephony service unit 220 in step 425, and then the telephony service unit 220 transmits the advertisement reception completion information to the IGD service unit 210. The IGD service unit 210 having received the reception completion information performs a port mapping in order to enable the mobile device 300 to use the free telephony service in step 429.

The advertisement processing service unit 320 of the mobile device 300 notifies the telephony CP 310 that the free telephony service may be used at the moment when the reception of the advertisement is completed or the output of the advertisement data is completed in step 427. When the process is completed, the mobile device 300 can access an internet network through the mobile gateway 200 and then use the free telephony service in step 431. Next, referring to FIG. 8, a process is described in which, when the gateway determines that the electronic device has no outside network access right, the gateway induces an advertisement reception of the electronic device and makes the electronic device access information on the advertisement, which is to be received by the electronic device, from the gateway according to the second embodiment of the present invention. Accordingly, the mobile gateway 200 includes the advertisement service unit 240 instead of the advertisement CP 230, and the mobile device 300 includes the advertisement processing CP 330 instead of the advertisement service unit 320.

Referring to FIG. 8, when the user having the mobile device 300 gets on a bus, the mobile device 300 receives an allocation of an IP address from the IGD service unit 210 of the mobile gateway 200 in step 501.

At this time, the IGD service unit 210 within the mobile gateway 200 blocks an outside network port in order to enable the user mobile device 300 having received the allocation of the IP address in step 503 not to use an outside network service.

The telephony CP 310 of the mobile device 300 and the advertisement processing CP 330 identify the telephony service unit 220 and the advertisement service unit 240 through the discovery process and the description process in step 505 and step 507, respectively.

Accordingly, the mobile device 300 can notify the user that the mobile device has accessed the mobile gateway 200, and provide a kind of services, which can be provided in a network by the mobile gateway 200. The kind of services will be provided by the telephony service unit 220 of the mobile gateway 200. The service, which can be provided, may includes a service, which should use an outside network, for example, a free telephony service, and an internet service. The user can select the free telephony service to use a free phone service, and accordingly, the telephony CP 310 transmits a service request message for calling the free telephony service provided by the telephony service unit 220 within the mobile gateway 200 in step 509.

When the telephony service unit 220 of the mobile gateway 200 receives the request message, the telephony service 220 identifies outside network access right information of the mobile device 300. As a result of the identification, when the information is stored such that the access is not allowed, the telephony service unit 220 transmits an response message of informing that the service is restricted because the mobile device 300 has not viewed the current service advertisement to the telephony CP 310 of the mobile device 300 in response to the call of the free telephony service in step 511. Accordingly, the mobile device 300 can notify the user that the access is not allowed through a message display. At this time, the mobile device 300 can notify the user that the service is available when the user receives the advertisement. Further, the response message contains information including a request for performing the advertisement service to the advertisement processing CP 330 of the mobile device 300.

Further, the telephony service unit 310 of the mobile device 300 calls the advertisement processing CP 330 according to an advertisement service performance request included in the response message in step 513.

The advertisement processing CP 330 of the mobile device 300 transmits an advertisement service request message to the advertisement service unit 240 of the mobile gateway 200 in step 515.

Accordingly, the advertisement service unit 240 transmits advertisement URL information indicating a location of advertisement contents to the advertisement processing CP 330 of the mobile device 300 in step 517.

The advertisement processing CP 330 of the mobile device 300 transmits an advertisement transmission request message to the received advertisement URL in step 519.

The advertisement service unit 240 of the gateway 200 having received the advertisement transmission request message transmits corresponding advertisement data to the advertisement processing CP 330 of the mobile device 300. At this time, the transmitted advertisement data may be stored in the mobile gateway 300 in advance, or received from an outside advertisement provider.

When the reception of the advertisement data is completed, the advertisement processing CP 330 of the mobile device 300 can automatically output the advertisement data, or output the advertisement data according to a user selection. For example, when the advertisement data is a dynamic image, the dynamic image may be automatically reproduced, or may be reproduced after a reproduction command of the user is received.

Further, the advertisement processing CP 330 transmits an advertisement viewing report message including information indicating the completion of the advertisement reception to the advertisement CP 230 at the moment when the advertisement reception is completed, or transmits an advertisement viewing report message including information indicating the completion of the advertisement viewing to the advertisement CP 230 at the moment when the output of the advertisement data is completed.

When the advertisement viewing report message is received, the advertisement service unit 240 transmits advertisement reception completion information to the telephony service unit 220 in step 525, and then the telephony service unit 220 transmits the advertisement reception completion information to the IGD service unit 210. The IGD service unit 210 having received the reception completion information performs a port mapping in order to enable the mobile device 300 to use the free telephony service in step 529.

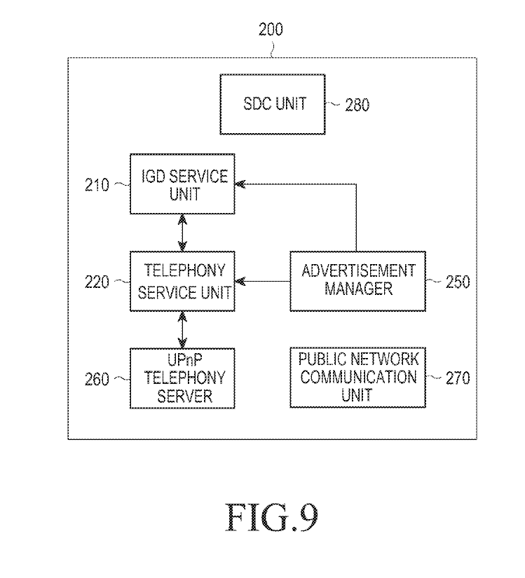

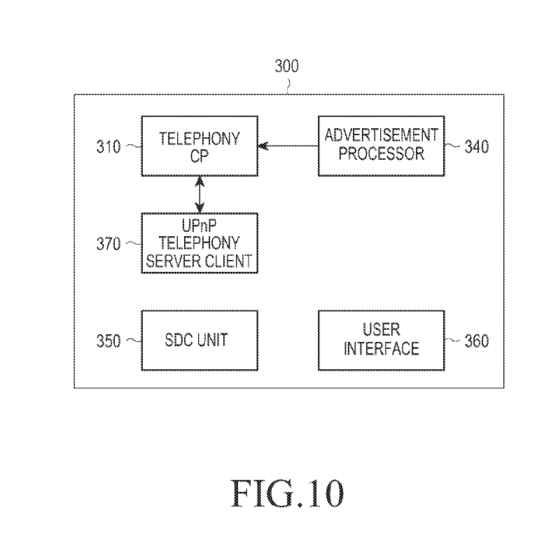

The advertisement processing CP 330 of the mobile device 300 notifies the telephony CP 310 that the free telephony service may be used at the moment when the advertisement reception is completed or the output of the advertisement data is completed in step 517. When the process is completed, the mobile device 300 can use the free telephony service in step 531. The present invention may be applied to various services using an outside network as well as the telephony service. FIGS. 9 and 10 illustrate constructions of the mobile gateway 200 and the mobile device 200 in a case where the free telephony service is provided.

Referring to FIG. 9, the mobile gateway 200 includes the IGD service unit 210, the telephony service unit 220, an advertisement manager 250, a UPnP telephony server 260, a public network communication unit 270, and a Short Distance Communicaiton (SDC) unit 280.

The SDC unit 280 is a module, which performs short distance communicaiton with the mobile device 300. Each message shown in FIGS. 7 and 8 are transmitted/received through the SDC unit 280. For example, the short distance communicaiton can be one of Blue tooth communicaiton, ZigBee communication, and Wi-Fi(wireless fidelity) communication.

The public network communication unit 270 performs communication with an outside network, for example, a mobile communication network, an internet network, and a public network. For example, the public network communication unit 270 is used to receive advertisement data provided by a service provider or to access an outside network for the telephony service or an internet service.

The IGD service unit 210 and the telephony service unit 220 are operated as described above.

The advertisement manager 250 may be one of the advertisement CP 230 and the advertisement service unit 240, and are operated as described above.

The UPnP telephony server 260 operates similarly as the UPnP telephony server 106 of FIG. 2. At this time, a function of the UPnP telephony control point 102 is performed by the telephony CP 310. That is, according to processes of FIG. 7 or FIG. 8, when the mobile device 300 is eligible for an access to an outside network, the telephony service is provided through the UPnP telephony server 260, a UPnP telephony client 370, the telephony CP 310, and a telephony application (not shown).

The telephony application is an application, which provides a telephony function. For example, the telephony application may include an IP telephone application and is stored in the mobile gateway 200.

Referring to FIG. 10, the mobile device 300 includes the telephony CP 310, an advertisement processor 340, the UPnP telephony client 370, a Short Distance Communicaiton (SDC) unit 350, and a user interface 360.

The SDC unit 350 is a module, which performs short distance communicaiton with the mobile gateway 200. Each message shown in FIGS. 7 and 8 is transmitted/received through the SDC unit 350.

The user interface 360 is a device, which can receive a user input. For example, the user interface 360 may include one or more of various keys, a touch screen, and a microphone. Further, the user interface 360 includes various output devices, for example, a display screen, and a speaker to provide an interface function between mobile devices 300.

The telephony CP 310 operates as described above.

The advertisement processor 340 may be one of the advertisement processing service unit 320 and the advertisement processing CP 310, and operates as described above.

The UPnP telephony client 370 operates similarly as the UPnP telephony client 109 of FIG. 2. At this time, a function of the UPnP telephony control point 102 is performed by the telephony CP 310. That is, according to processes of FIG. 7 or FIG. 8, when the mobile device 300 is eligible for an access to an outside network, the telephony service is provided through the UPnP telephony server 260, the UPnP telephony client 370, and the telephony CP 310.

As described above, the present invention provides the method and the apparatus for allowing a user to use the telephony service by using a public infrastructure.

Further, the present invention provides the method and the apparatus in which a user receives an advertisement including an image, voice, and a text for the use of the free telephony service by using a public infrastructure.

Moreover, the present invention provides the method and the apparatus for a service access restriction for allowing only a user device having received an advertisement to use the telephony service.

Furthermore, the present invention may be applied to various services such as an advertisement viewing based internet use service as well as the advertisement viewing based telephony service in a public place.

In addition, the present invention may be applied to the use of the free telephony service within the home as well as the use of the free telephony service in a public place.

Further, the present invention provides an advertisement to a telephony client which desires to use the telephony service in a public place.

Further, the present invention provides a use right in order to allow only a telephony client having received an advertisement to use the telephony service.

Further, the present invention enables a user to use the free telephony service by using a telephony client such as a TV within the home.

In accordance with an aspect of the present invention, there is provided a method of performing Short Distance Communicaiton with at least one electronic device and providing a service using an outside network to the electronic device, the method including allocating an IP address to an electronic device and blocking an outside network access of the electronic device; receiving a request message for an outside network service from the electronic device; identifying whether the electronic device has an access right for an outside network; when the electronic device has no access right, transmitting an advertisement to the electronic device; when an advertisement viewing report message is received from the electronic device, giving the access right to the electronic device and allowing an access to the outside network; and providing the outside network service to the electronic device.

The method further comprises transmitting a message indicating that the outside network service is not allowed, to the electronic device when the electronic device has no access right.

Wherein transmitting of the advertisement to the electronic device comprises: transmitting location information of the advertisement, which is to be received, to the electronic device; receiving an advertisement request message including the location information from the electronic device; and transmitting advertisement data corresponding to the location information to the electronic device.

Wherein transmitting of the advertisement to the electronic device comprises: transmitting a request message for requesting the electronic device to receive the advertisement; receiving an advertisement request message from the electronic device; transmitting location information of the advertisement, which is to be received, to the electronic device; receiving an advertisement request message including the location information from the electronic device; and transmitting advertisement data corresponding to the location information to the electronic device.

In accordance with an aspect of the present invention, there is provided a gateway apparatus for performing Short Distance Communicaiton with at least one electronic device, establishing a network, and providing a service using an outside network to the electronic device, the gateway apparatus comprising: a Short Distance Communicaiton unit for performing Short Distance Communicaiton with an electronic device; a public network communication unit for performing communication with the outside network; an IGD service unit for allocating an IP address to the electronic device, blocking an outside network access of the electronic device, and allowing the outside network access of the electronic device according to a request of a telephony service unit; and the telephony service unit for identifying whether the electronic device has an access right for the outside network when a request message for an outside network service is received from the electronic device, transmitting an advertisement to the electronic device through an advertisement manager when the electronic device has no access right, and, when an advertisement viewing report message is received from the electronic device, giving an access right to the electronic device, requesting the IGD service unit to allow an outside network access of the electronic device, and providing the outside network service to the electronic device.

Wherein, when the electronic device has no access right, the telephony service unit transmits a message indicating that the outside network service is not allowed, to the electronic device.

Wherein, when the electronic device has no access right, the telephony service unit transmits an advertisement transmission command to the advertisement manager, wherein the advertisement manager transmits location information of the advertisement, which is to be received, to the electronic device through the Short Distance Communicaiton unit, receives an advertisement request message including the location information from the electronic device, transmitting advertisement data corresponding to the location information to the electronic device, receiving the advertisement viewing report message, and notifying the telephony service unit of the advertisement viewing report message.

Wherein, when the electronic device has no access right, the telephony service unit transmits a request message for requesting the electronic device to receive an advertisement, and the advertisement manager receives an advertisement request message from the electronic device, transmits location information of an advertisement, which is to be received, to the electronic device, receives an advertisement request message including the location information from the electronic device, and transmits advertisement data corresponding to the location information to the electronic device.

In accordance with an aspect of the present invention, there is provided a method for receiving a service using an outside network from a gateway, which performs Short Distance Communicaiton with one or more electronic devices and establishes a network, by a particular electronic device among the one or more electronic devices, the method comprising: receiving an allocation of an IP address from the gateway; transmitting a request message for an outside network service to the gateway; receiving a notification that the electronic device has no access right for a network from the gateway; receiving an advertisement from the gateway; transmitting an advertisement viewing report message corresponding to the advertisement to the gateway; and receiving the outside network service from the gateway.

Wherein receiving of the advertisement comprises: receiving location information of the advertisement, which is to be received, from the gateway; transmitting an advertisement request message including the location information to the gateway; and receiving advertisement data corresponding to the location information from the gateway.

Wherein receiving of the advertisement comprises: receiving a request message for requesting to receive the advertisement from the gateway; transmitting an advertisement request message to the gateway; receiving location information of the advertisement to be received, from the gateway; transmitting an advertisement viewing report message corresponding to the advertisement to the gateway; and receiving the outside network service from the gateway.

In accordance with an aspect of the present invention, there is provided an electronic device for receiving a service using an outside network from a gateway, which performs Short Distance Communicaiton with one or more electronic devices and establishes a network, the one or more electronic devices including the electronic device, the electronic device comprising: a Short Distance Communicaiton unit for performing Short Distance Communicaiton with the gateway; a telephony CP for receiving an allocation of an IP address from the gateway, transmitting a request message for an outside network service to the gateway, and receiving a notification that the electronic device has no access right for a network from the gateway; and an advertisement processor for receiving an advertisement from the gateway, and transmitting an advertisement viewing report corresponding to the advertisement to the gateway and the telephony CP, wherein, when the telephony CP receives the advertisement viewing report, the telephony CP receives the outside network service from the gateway.

Wherein an advertisement processor receives location information of the advertisement to be received from the gateway, transmits an advertisement request message including the location information to the gateway, and receives advertisement data corresponding to the location information from the gateway.

Wherein the advertisement processor receives a request message for requesting to receive an advertisement from the gateway, transmits an advertisement request message to the gateway, receives location information of an advertisement to be received from the gateway, transmits an advertisement request message including the location information to the gateway, and receives advertisement data corresponding to the location information from the gateway.

While the present invention has been shown and described with reference to certain exemplary embodiments and drawings thereof, it will be understood by those skilled in the art that various changes in form and details may be made therein without departing from the spirit and scope of the invention as defined by the appended claims.

1. A method of performing Short Distance Communicaiton with at least one electronic device and providing a service using an outside network to the electronic device, by a gateway establishing a network, the method comprising:
allocating an IP address to an electronic device and blocking an outside network access of the electronic device;
receiving a request message for an outside network service from the electronic device;
identifying whether the electronic device has an access right for an outside network;
when the electronic device has no access right, transmitting an advertisement to the electronic device;
when an advertisement viewing report message is received from the electronic device, giving the access right to the electronic device and allowing an access to the outside network; and
providing the outside network service to the electronic device.

2. The method as claimed in claim 1, further comprising transmitting a message indicating that the outside network service is not allowed, to the electronic device when the electronic device has no access right.

3. The method as claimed in claim 1, wherein transmitting of the advertisement to the electronic device comprises:
transmitting location information of the advertisement, which is to be received, to the electronic device;
receiving an advertisement request message including the location information from the electronic device; and
transmitting advertisement data corresponding to the location information to the electronic device.

4. The method as claimed in claim 1, wherein transmitting of the advertisement to the electronic device comprises:
transmitting a request message for requesting the electronic device to receive the advertisement;
receiving an advertisement request message from the electronic device;
transmitting location information of the advertisement, which is to be received, to the electronic device;
receiving an advertisement request message including the location information from the electronic device; and
transmitting advertisement data corresponding to the location information to the electronic device.

5. A gateway apparatus for performing Short Distance Communicaiton with at least one electronic device, establishing a network, and providing a service using an outside network to the electronic device, the gateway apparatus comprising:
a Short Distance Communicaiton unit for performing Short Distance Communicaiton with an electronic device;
a public network communication unit for performing communication with the outside network;
an IGD service unit for allocating an IP address to the electronic device, blocking an outside network access of the electronic device, and allowing the outside network access of the electronic device according to a request of a telephony service unit; and
the telephony service unit for identifying whether the electronic device has an access right for the outside network when a request message for an outside network service is received from the electronic device, transmitting an advertisement to the electronic device through an advertisement manager when the electronic device has no access right, and, when an advertisement viewing report message is received from the electronic device, giving an access right to the electronic device, requesting the IGD service unit to allow an outside network access of the electronic device, and providing the outside network service to the electronic device.

6. The gateway apparatus as claimed in claim 5, wherein, when the electronic device has no access right, the telephony service unit transmits a message indicating that the outside network service is not allowed, to the electronic device.

7. The gateway apparatus as claimed in claim 6, wherein, when the electronic device has no access right, the telephony service unit transmits an advertisement transmission command to the advertisement manager,
wherein the advertisement manager transmits location information of the advertisement, which is to be received, to the electronic device through the Short Distance Communicaiton unit, receives an advertisement request message including the location information from the electronic device, transmitting advertisement data corresponding to the location information to the electronic device, receiving the advertisement viewing report message, and notifying the telephony service unit of the advertisement viewing report message.

8. The gateway apparatus as claimed in claim 6, wherein, when the electronic device has no access right, the telephony service unit transmits a request message for requesting the electronic device to receive an advertisement, and the advertisement manager receives an advertisement request message from the electronic device, transmits location information of an advertisement, which is to be received, to the electronic device, receives an advertisement request message including the location information from the electronic device, and transmits advertisement data corresponding to the location information to the electronic device.

9. A method for receiving a service using an outside network from a gateway, which performs Short Distance Communicaiton with one or more electronic devices and establishes a network, by a particular electronic device among the one or more electronic devices, the method comprising:
receiving an allocation of an IP address from the gateway;
transmitting a request message for an outside network service to the gateway;
receiving a notification that the electronic device has no access right for a network from the gateway;
receiving an advertisement from the gateway;
transmitting an advertisement viewing report message corresponding to the advertisement to the gateway; and
receiving the outside network service from the gateway.

10. The method as claimed in claim 9, wherein receiving of the advertisement comprises:
receiving location information of the advertisement, which is to be received, from the gateway;
transmitting an advertisement request message including the location information to the gateway; and
receiving advertisement data corresponding to the location information from the gateway.

11. The method as claimed in claim 9, wherein receiving of the advertisement comprises:
receiving a request message for requesting to receive the advertisement from the gateway;
transmitting an advertisement request message to the gateway;
receiving location information of the advertisement to be received, from the gateway;
transmitting an advertisement viewing report message corresponding to the advertisement to the gateway; and
receiving the outside network service from the gateway.

12. An electronic device for receiving a service using an outside network from a gateway, which performs Short Distance Communicaiton with one or more electronic devices and establishes a network, the one or more electronic devices including the electronic device, the electronic device comprising:
a Short Distance Communicaiton unit for performing Short Distance Communicaiton with the gateway
a telephony CP for receiving an allocation of an IP address from the gateway, transmitting a request message for an outside network service to the gateway, and receiving a notification that the electronic device has no access right for a network from the gateway; and
an advertisement processor for receiving an advertisement from the gateway, and transmitting an advertisement viewing report corresponding to the advertisement to the gateway and the telephony CP, wherein, when the telephony CP receives the advertisement viewing report, the telephony CP receives the outside network service from the gateway.

13. The electronic device apparatus as claimed in claim 12, wherein an advertisement processor receives location information of the advertisement to be received from the gateway, transmits an advertisement request message including the location information to the gateway, and receives advertisement data corresponding to the location information from the gateway.

14. The electronic device apparatus as claimed in claim 12, wherein the advertisement processor receives a request message for requesting to receive an advertisement from the gateway, transmits an advertisement request message to the gateway, receives location information of an advertisement to be received from the gateway, transmits an advertisement request message including the location information to the gateway, and receives advertisement data corresponding to the location information from the gateway.
